(19) United States
(12) Patent Application Publication
(10) Pub. No.: US 2024/0063389 A1
(43) Pub. Date: Feb. 22, 2024

(54) PREPARATION METHOD OF HARD CARBON ANODE MATERIAL AND USE THEREOF

(71) Applicants: GUANGDONG BRUNP RECYCLING TECHNOLOGY CO., LTD., Foshan (CN); HUNAN BRUNP RECYCLING TECHNOLOGY CO., LTD., Changsha (CN); HUNAN BRUNP EV RECYCLING CO., LTD., Changsha (CN)

(72) Inventors: Xingyu Wu, Foshan (CN); Changdong Li, Foshan (CN); Maohua Feng, Foshan (CN); Dingshan Ruan, Foshan (CN); Bin Li, Foshan (CN); Qianyi Tan, Foshan (CN)

(21) Appl. No.: 18/385,416

(22) Filed: Oct. 31, 2023

Related U.S. Application Data
(63) Continuation of application No. PCT/CN2023/077221, filed on Feb. 20, 2023.

(30) Foreign Application Priority Data
Apr. 21, 2022 (CN) 202210421738.X

(51) Int. Cl. H01M 4/587; C01B 32/05

(52) U.S. Cl. CPC H01M 4/587; C01B 32/05; C01P 2002/72; C01P 2004/03; C01P 2006/12; C01P 2006/40; H01M 2004/027

(57) ABSTRACT

The present disclosure discloses a preparation method of a hard carbon (HC) anode material and use thereof. The preparation method includes the following steps: mixing a substance A, a first alcohol liquid, and an oxidant to obtain a peroxide gel of the substance A, and dissolving a substance B in a second alcohol liquid to obtain an amino-containing solution; mixing the peroxide gel of the substance A with the amino-containing solution to allow a reaction to obtain a post-reaction slurry; and lyophilizing the post-reaction slurry to obtain a dry powder, subjecting the dry powder to calcination in a protective atmosphere to obtain a calcined material, soaking the calcined material in an acid liquid, and water-washing and drying to obtain the HC anode material.

### CROSS-REFERENCE TO RELATED APPLICATIONS

The present application is a continuation application of PCT application No. PCT/CN2023/077221 filed on Feb. 20, 2023, which claims the benefit of Chinese Patent Application No. 202210421738.X filed on Apr. 21, 2022. The contents of all of the aforementioned applications are incorporated by reference herein in their entirety.

### TECHNICAL FIELD

The present disclosure belongs to the technical field of secondary battery anode materials, and specifically relates to a preparation method of a hard carbon (HC) anode material and use thereof.

### BACKGROUND

With the depletion of traditional energy sources, more attention is drawn to energy storage systems (ESSs). As a new generation of energy storage products, lithium-ion batteries (LIBs) have attracted great attention from researchers. However, lithium resources are limited, and as the demand for LIBs continues to grow, lithium resources may be in short supply. Sodium exhibits similar chemical properties to lithium and is abundant. Therefore, the concept of sodium-ion battery (SIB) is proposed, and SIB is regarded as the most desirable substitute for LIB.

However, the interlayer spacing of traditional graphite anode material is too small for the deintercalation of sodium ions as the radius of a sodium ion is larger than that of a lithium ion. Therefore, it is necessary to develop carbon anode materials with large interlayer spacing and pores. HC is currently the most promising anode material for SIBs due to its large interplanar spacing. At present, HC anode materials show a poor effect in the practical application of anode materials due to low reversible specific capacity and poor initial efficiency, and thus have a small market share, which limits the application of HC anode materials in SIBs.

### SUMMARY

The present disclosure is intended to solve at least one of the technical problems existing in the prior art. In view of this, the present disclosure provides a preparation method of an HC anode material and use thereof.

According to an aspect of the present disclosure, a preparation method of an HC anode material is provided, including the following steps:
S1: mixing a substance A, a first alcohol liquid, and an oxidant to obtain a peroxide gel of the substance A, and dissolving a substance B in a second alcohol liquid to obtain an amino-containing solution, where the substance A is at least one selected from the group consisting of a chloride and a sulfate of zirconium, germanium, and tin, and the substance B is a diamine;
S2: mixing the peroxide gel of the substance A with the amino-containing solution to allow a reaction to obtain a post-reaction slurry; and
S3: lyophilizing the post-reaction slurry to obtain a dry powder, subjecting the dry powder to calcination in a protective atmosphere to obtain a calcined material, and soaking the calcined material in an acid liquid to obtain the HC anode material.

In some embodiments of the present disclosure, in S1, the first alcohol liquid and/or the second alcohol liquid may be at least one selected from the group consisting of methanol, ethanol, 1-propanol, 2-propanol, ethylene glycol (EG), and glycerol; and a solid-to-liquid ratio of the substance A to the first alcohol liquid may be (1-5):100 g/mL.

In some embodiments of the present disclosure, in S1, the substance A may be dissolved in the first alcohol liquid and then the oxidant may be added, both of which are conducted at 0° C. to 10° C.

In some embodiments of the present disclosure, in S1, the oxidant may be 20 wt % to 45 wt % H₂O₂, and a solid-to-liquid ratio of the substance A to the oxidant may be (1-10):(80-100) g/mL.

In some embodiments of the present disclosure, in S1, the diamine may be at least one selected from the group consisting of diaminotoluene, phenylenediamine, p-xylylenediamine, ethylenediamine (EDA), propanediamine (PDA), butanediamine (BDA), naphthylenediamine, and cyclohexanediamine; and a solid-to-liquid ratio of the substance B to the second alcohol liquid may be (15-30):100 g/mL.

In some embodiments of the present disclosure, in S2, a process of the mixing to allow the reaction may be as follows: pumping the peroxide gel of the substance A through a first shunt pipe, pumping the amino-containing solution through a second shunt pipe, and pumping an alcohol liquid or an oxidant through an adjustment pipe, where the first shunt pipe, the second shunt pipe, and the adjustment pipe are joined to a confluence pipe, and a plurality of confluence pipes are joined to a main pipe; and the peroxide gel of the substance A and the amino-containing solution are mixed and react in the pipes, and finally the post-reaction slurry is obtained in the main pipe.

In some embodiments of the present disclosure, in S2, the peroxide gel of the substance A may be fed through the first shunt pipe at a flow rate of 0.0001 m³/min to 0.001 m³/min, and the amino-containing solution may be fed through the second shunt pipe at a flow rate of 0.00015 m³/min to 0.002 m³/min.

In some embodiments of the present disclosure, in S2, an oxygen content of a reaction material in the confluence pipes and the main pipe may be controlled at 2,400 ppm to 8,000 ppm by controlling a pumping amount of the alcohol liquid or the oxidant.

In some embodiments of the present disclosure, in S2, there may be a plurality of first shunt pipes, a plurality of second shunt pipes, and a plurality of adjustment pipes; one first shunt pipe, one second shunt pipe, and one adjustment pipe may be joined to one confluence pipe; a plurality of confluence pipes may be joined to one main pipe to form a tree structure; and the tree structure may be preferably an inverted tree structure. The materials flow from bottom to top under the action of a pump, which can slow down the flow of the materials, prolong the contact and reaction time of the materials, and allow sufficient reaction. In the present disclosure, the inverted tree structure adopted allows in-situ polymerization reactions to take place, this overcomes the disadvantage of a conventional reactor, in which reaction fluids cannot properly contact each other. As a result, it is possible to achieve more homologous mixing. In the present disclosure, the shunt pipes shunt micro-oxygen control, the confluence pipes allow confluence control, and the main pipe forms an inverted tree structure. Reactions take place through mixing in small batches for multiple times instead of mixing in large batches for a long time. Consequentially, molecules in the liquid phase have increased disorder. In addition, the flow rate in each pipe is controlled such that reaction time is extended to allow more sufficient in-situ polymerization reaction; the polymerized material obtained has superior performance as a result.

In some embodiments of the present disclosure, in S2, a reaction material in the confluence pipes and the main pipe may be treated for 6 h to 18 h in total. When reaching a confluence pipe, the raw materials from respective shunt pipes are mixed and react in the confluence pipe; a resulting reaction material flows to a main pipe and stays in the main pipe to make the reaction sufficient; and after the reaction is completed, a product is directly discharged from the main pipe.

In some embodiments of the present disclosure, in S2, the reaction material in the confluence pipe may be treated for 3 h to 9 h, and the reaction material in the main pipe may be treated for 3 h to 9 h. Further, a pumping rate of the confluence pipe may be 0.0002 m³/min to 0.002 m³/min.

In some embodiments of the present disclosure, in S2, the pumping may be conducted under a pressure of 0.15 MPa to 0.45 MPa.

In some embodiments of the present disclosure, in S3, the acid liquid may be 0.5 wt % to 5 wt % hydrochloric acid; and a solid-to-liquid ratio of the calcined material to the acid liquid may be (1-10):100 g/mL.

In some embodiments of the present disclosure, in S3, the lyophilizing may be conducted at −45° C. to −40° C. for 20 h to 24 h.

In some embodiments of the present disclosure, in S3, the calcination may be conducted at 700° C. to 1,000° C.

In some embodiments of the present disclosure, in S3, after the soaking in the acid liquid, an operation of water-washing may be further conducted.

The present disclosure also provides use of the preparation method described above in the preparation of a secondary battery anode material.

According to a preferred embodiment of the present disclosure, the present disclosure at least has the following beneficial effects:

In the present disclosure, the peroxide gel of substance A not only initiates the in-situ polymerization of the amino groups in the amino-containing solution, but also acts as a hard template for pore formation: the porous HC anode material obtained after high-temperature and acidification treatments has a desirable porous, multi-walled, and multi-granular structure. The in-situ polymerization of amino groups allows the blending of a zirconium/germanium/tin peroxide gel into the polymer; after high-temperature treatment, the zirconium/germanium/tin peroxide gel becomes metal oxide particles, these particles over-grow and can be granulated and aggregated multiple times; acid-pickling treatment removes most of the zirconium/germanium/tin oxide to vacate these zirconium/germanium/tin positions. As a result, most of the HC anode materials are relatively thin and have a porous and multi-walled structure. Nano- and low-micron activated carbon particles in the porous, multi-walled structure allow shortened transport distance of sodium ions and electrons, and effectively improve the high capacity of a current active substance to improve energy density. The material's porous, multi-walled structure and high specific surface area (SSA) increase its cycling stability.

### BRIEF DESCRIPTION OF THE DRAWINGS

The present disclosure is further described below with reference to accompanying drawings and examples.

FIG. 1 is an X-ray diffractometry (XRD) pattern of the porous HC anode material prepared in Example 3 of the present disclosure;

FIG. 2 is a scanning electron microscopy (SEM) image of the porous HC anode material prepared in Example 3 of the present disclosure at a low magnification; and

FIG. 3 is an SEM image of the porous HC anode material prepared in Example 3 of the present disclosure at a high magnification.

### DETAILED DESCRIPTION

The concepts and technical effects of the present disclosure are clearly and completely described below in conjunction with examples, so as to allow the objectives, features and effects of the present disclosure to be fully understood. Apparently, the described examples are merely some rather than all of the examples of the present disclosure. All other examples obtained by those skilled in the art based on the examples of the present disclosure without creative efforts should fall within the protection scope of the present disclosure.

### Example 1

In this example, a porous HC anode material was prepared, and a specific preparation process was as follows:

(1) Zirconium chloride was mixed with methanol (in a solid-to-liquid ratio of 1.5:100 g/mL), then 24.7 wt % H₂O₂ was added (a solid-to-liquid ratio of the zirconium chloride to the oxidant was 1.5:80 g/mL), and a resulting mixture was mixed at 5° C. to obtain a peroxide gel of zirconium chloride; BDA was dissolved in methanol to obtain a BDA solution (a solid-to-liquid ratio of the BDA to the methanol was 15:100 g/mL); and the BDA solution and the peroxide gel of zirconium chloride were each stored in a sealed container.

(2) The peroxide gel of zirconium chloride and the BDA solution were each drawn out from the container through a shunt pipe (a pressure of the shunt pipe was 0.17 MPa); and the peroxide gel of zirconium chloride was pumped in a shunted way through two shunt pipes (at a flow rate of 0.00020 m³/min), and the BDA solution was pumped in a shunted way through two shunt pipes (at a flow rate of 0.00045 m³/min), where a shunt pipe carrying the peroxide gel of zirconium chloride, a shunt pipe carrying the BDA solution, and an adjustment pipe were joined to a confluence pipe, and a pumping speed of the confluence pipe was 0.00052 m³/min; an oxygen content of a reaction material in the confluence pipe was controlled at 3,000 ppm to 5,000 ppm (tested with an on-line oxygen meter) by pumping an alcohol liquid through the adjustment pipe; a plurality of confluence pipes were joined to a main pipe to form an inverted tree structure; the reaction material in each of the confluence pipes and the main pipe was treated for 3 h; and finally a post-reaction slurry was obtained in the main pipe.

(3) The post-reaction slurry was lyophilized at −45° C. for 20 h and then crushed to obtain a dry powder, the dry powder was subjected to calcination at 745° C. for 10 h in a tube furnace under a nitrogen atmosphere to obtain a calcined material, and the calcined material was soaked in 0.72 wt % hydrochloric acid for acidification (a solid-to-liquid ratio of the calcined material to the hydrochloric acid was 1.5:100 g/mL), filtered out, repeatedly washed with deionized water, and dried to obtain the porous HC anode material.

### Example 2

In this example, a porous HC anode material was prepared, and a specific preparation process was as follows:

(1) Germanium sulfate was mixed with methanol (in a solid-to-liquid ratio of 2:100 g/mL), then 12.4 wt % H₂O₂ was added (a solid-to-liquid ratio of the germanium sulfate to the oxidant was 2:80 g/mL), and a resulting mixture was mixed at 5° C. to obtain a peroxide gel of germanium sulfate; BDA was dissolved in methanol to obtain a BDA solution (a solid-to-liquid ratio of the BDA to the methanol was 15:100 g/mL); and the BDA solution and the peroxide gel of germanium sulfate were each stored in a sealed container.

(2) The peroxide gel of germanium sulfate and the BDA solution were each drawn out from the container through a shunt pipe (a pressure of the shunt pipe was 0.17 MPa); and the peroxide gel of germanium sulfate was pumped in a shunted way through two shunt pipes (at a flow rate of 0.00025 m³/min), and the BDA solution was pumped in a shunted way through two shunt pipes (at a flow rate of 0.00060 m³/min), where a shunt pipe carrying the peroxide gel of germanium sulfate, a shunt pipe carrying the BDA solution, and an adjustment pipe were joined to a confluence pipe, and a pumping speed of the confluence pipe was 0.00068 m³/min; an oxygen content of a reaction material in the confluence pipe was controlled at 2,400 ppm to 5,000 ppm (tested with an on-line oxygen meter) by pumping an alcohol liquid through the adjustment pipe; a plurality of confluence pipes were joined to a main pipe to form an inverted tree structure; the reaction material in each of the confluence pipes and the main pipe was treated for 6.5 h; and finally a post-reaction slurry was obtained in the main pipe.

(3) The post-reaction slurry was lyophilized at −40° C. for 6 h and then crushed to obtain a dry powder, the dry powder was subjected to calcination at 880° C. for 10 h in a tube furnace under a nitrogen atmosphere to obtain a calcined material, and the calcined material was soaked in 0.72 wt % hydrochloric acid for acidification (a solid-to-liquid ratio of the calcined material to the hydrochloric acid was 2:100 g/mL), filtered out, repeatedly washed with deionized water, and dried to obtain the porous HC anode material.

### Example 3

In this example, a porous HC anode material was prepared, and a specific preparation process was as follows:

(1) Zirconium chloride was mixed with methanol (in a solid-to-liquid ratio of 3.5:100 g/mL), then 16.25 wt % H₂O₂ was added (a solid-to-liquid ratio of the zirconium chloride to the oxidant was 7:80 g/mL), and a resulting mixture was mixed at 4° C. to obtain a peroxide gel of zirconium chloride; BDA was dissolved in methanol to obtain a BDA solution (a solid-to-liquid ratio of the BDA to the methanol was 15:100 g/mL); and the BDA solution and the peroxide gel of zirconium chloride were each stored in a sealed container.

(2) The peroxide gel of zirconium chloride and the BDA solution were each drawn out from the container through a shunt pipe (a pressure of the shunt pipe was 0.35 MPa); and the peroxide gel of zirconium chloride was pumped in a shunted way through two shunt pipes (at a flow rate of 0.00075 m³/min), and the BDA solution was pumped in a shunted way through two shunt pipes (at a flow rate of 0.0015 m³/min), where a shunt pipe carrying the peroxide gel of zirconium chloride, a shunt pipe carrying the BDA solution, and an adjustment pipe were joined to a confluence pipe, and a pumping speed of the confluence pipe was 0.00072 m³/min; an oxygen content of a reaction material in the confluence pipe was controlled at 3,200 ppm to 6,000 ppm (tested with an on-line oxygen meter) by pumping H₂O₂ through the adjustment pipe; a plurality of confluence pipes were joined to a main pipe to form an inverted tree structure; the reaction material in each of the confluence pipes and the main pipe was treated for 4 h; and finally a post-reaction slurry was obtained in the main pipe.

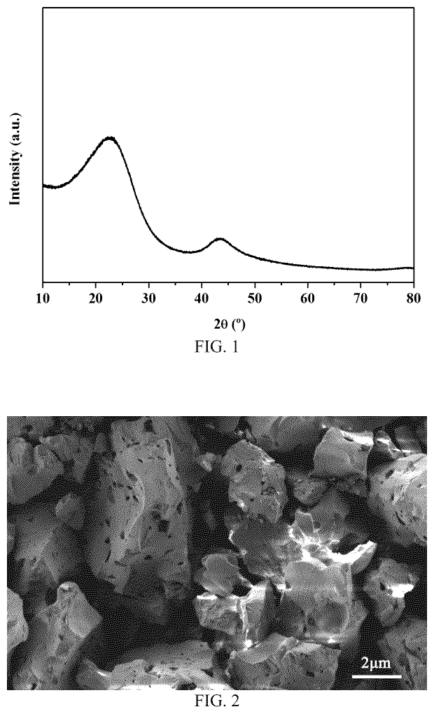

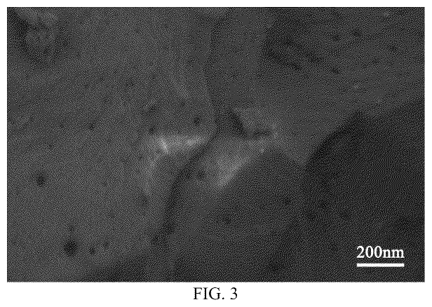

(3) The post-reaction slurry was lyophilized at −40° C. for 6 h and then crushed to obtain a dry powder, the dry powder was subjected to calcination at 800° C. for 10 h in a tube furnace under a nitrogen atmosphere to obtain a calcined material, and the calcined material was soaked in 0.72 wt % hydrochloric acid for acidification (a solid-to-liquid ratio of the calcined material to the hydrochloric acid was 2:100 g/mL), filtered out, repeatedly washed with deionized water, and dried to obtain the porous HC anode material, and an X-ray diffractometry (XRD) pattern, a scanning electron microscopy (SEM) image and an SEM image of the porous HC anode material were shown in FIG. 1, FIG. 2 and FIG. 3 respectively.

### Comparative Example 1

In this comparative example, an HC anode material was prepared, which was different from Example 3 in that the reaction was conducted in a reactor. A specific preparation process was as follows:

(1) Zirconium chloride was mixed with methanol (in a solid-to-liquid ratio of 3.5:100 g/mL), then 16.25 wt % H₂O₂ was added (a solid-to-liquid ratio of the zirconium chloride to the oxidant was 7:80 g/mL), and a resulting mixture was mixed at 4° C. to obtain a peroxide gel of zirconium chloride; BDA was dissolved in methanol to obtain a BDA solution (a solid-to-liquid ratio of the BDA to the methanol was 15:100 g/mL); and the BDA solution and the peroxide gel of zirconium chloride were each stored in a sealed container.

(2) 5 L of the peroxide gel of zirconium chloride and 10 L of the BDA solution were mixed and stirred for 15 min in the reactor, then H₂O₂ was introduced to adjust an oxygen content in a reaction material to 3,200 ppm to 6,000 ppm, the reactor was sealed, and a stable treatment was conducted for 8 h to obtain a post-reaction slurry.

(3) The post-reaction slurry was lyophilized at −40° C. for 6 h and then crushed to obtain a dry powder, the dry powder was subjected to calcination at 800° C. for 10 h in a tube furnace under a nitrogen atmosphere to obtain a calcined material, and the calcined material was soaked in 0.72 wt % hydrochloric acid for acidification (a solid-to-liquid ratio of the calcined material to the hydrochloric acid was 2:100 g/mL), filtered out, repeatedly washed with deionized water, and dried to obtain the HC anode material.

### Comparative Example 2

In this comparative example, an HC anode material was prepared, which was different from Example 3 in that the oxygen content was not controlled in step (2). A specific preparation process was as follows:

(1) Zirconium chloride was mixed with methanol (in a solid-to-liquid ratio of 3.5:100 g/mL), then 16.25 wt % H₂O₂ was added (a solid-to-liquid ratio of the zirconium chloride to the oxidant was 7:80 g/mL), and a resulting mixture was mixed at 4° C. to obtain a peroxide gel of zirconium chloride; BDA was dissolved in methanol to obtain a BDA solution (a solid-to-liquid ratio of the BDA to the methanol was 15:100 g/mL); and the BDA solution and the peroxide gel of zirconium chloride were each stored in a sealed container.

(2) The peroxide gel of zirconium chloride and the BDA solution were each drawn out from the container through a shunt pipe (a pressure of the shunt pipe was 0.35 MPa); and the peroxide gel of zirconium chloride was pumped in a shunted way through two shunt pipes (at a flow rate of 0.00075 m³/min), and the BDA solution was pumped in a shunted way through two shunt pipes (at a flow rate of 0.0015 m³/min), where a shunt pipe carrying the peroxide gel of zirconium chloride and a shunt pipe carrying the BDA solution were joined to a confluence pipe, and a pumping speed of the confluence pipe was 0.00072 m³/min; a plurality of confluence pipes were joined to a main pipe to form an inverted tree structure; the reaction material in each of the confluence pipes and the main pipe was treated for 4 h; and finally a post-reaction slurry was obtained in the main pipe.

(3) The post-reaction slurry was lyophilized at −40° C. for 6 h and then crushed to obtain a dry powder, the dry powder was subjected to calcination at 800° C. for 10 h in a tube furnace under a nitrogen atmosphere to obtain a calcined material, and the calcined material was soaked in 0.72 wt % hydrochloric acid for acidification (a solid-to-liquid ratio of the calcined material to the hydrochloric acid was 2:100 g/mL), filtered out, repeatedly washed with deionized water, and dried to obtain the porous HC anode material.

### Comparative Example 3

In this comparative example, an HC anode material was prepared, which was different from Example 3 in that the treatment time in each of the confluence pipes and the main pipe in step (2) was not within the preferred range of the present disclosure. A specific preparation process was as follows:

(1) Zirconium chloride was mixed with methanol (in a solid-to-liquid ratio of 3.5:100 g/mL), then 16.25 wt % H₂O₂ was added (a solid-to-liquid ratio of the zirconium chloride to the oxidant was 7:80 g/mL), and a resulting mixture was mixed at 4° C. to obtain a peroxide gel of zirconium chloride; BDA was dissolved in methanol to obtain a BDA solution (a solid-to-liquid ratio of the BDA to the methanol was 15:100 g/mL); and the BDA solution and the peroxide gel of zirconium chloride were each stored in a sealed container.

(2) The peroxide gel of zirconium chloride and the BDA solution were each drawn out from the container through a shunt pipe (a pressure of the shunt pipe was 0.35 MPa); and the peroxide gel of zirconium chloride was pumped in a shunted way through two shunt pipes (at a flow rate of 0.00075 m³/min), and the BDA solution was pumped in a shunted way through two shunt pipes (at a flow rate of 0.0015 m³/min), where a shunt pipe carrying the peroxide gel of zirconium chloride, a shunt pipe carrying the BDA solution, and an adjustment pipe were joined to a confluence pipe, and a pumping speed of the confluence pipe was 0.00072 m³/min; an oxygen content of a reaction material in the confluence pipe was controlled at 3,200 ppm to 6,000 ppm (tested with an on-line oxygen meter) by pumping H₂O₂ through the adjustment pipe; a plurality of confluence pipes were joined to a main pipe to form an inverted tree structure; the reaction material in each of the confluence pipes and the main pipe was treated for 1 h; and finally a post-reaction slurry was obtained in the main pipe.

(3) The post-reaction slurry was lyophilized at −40° C. for 6 h and then crushed to obtain a dry powder, the dry powder was subjected to calcination at 800° C. for 10 h in a tube furnace under a nitrogen atmosphere to obtain a calcined material, and the calcined material was soaked in 0.72 wt % hydrochloric acid for acidification (a solid-to-liquid ratio of the calcined material to the hydrochloric acid was 2:100 g/mL), filtered out, repeatedly washed with deionized water, and dried to obtain the porous HC anode material.

### Comparative Example 4

In this comparative example, an HC anode material was prepared, which was different from Example 3 in that the steps (1) and (2) were omitted and no acid-pickling was involved in step (3). A specific preparation process was as follows:

BDA was dissolved in methanol to obtain a BDA solution (a solid-to-liquid ratio of the BDA to the methanol was 15:100 g/mL), a resulting solution was fully stirred for 2 h, lyophilized at −40° C. for 6 h, and then crushed to obtain a dry powder, and the dry powder was subjected to calcination at 800° C. for 10 h in a tube furnace under a nitrogen atmosphere to obtain the HC anode material.

Physical and Chemical Properties

TABLE 1
SSA and particle size distribution data of HC anode materials

| Sample | SSA (m²/g) | D10 (μm) | D50 (μm) | D90 (μm) |
|---|---|---|---|---|
| Example 1 | 189.8 | 0.44 | 1.46 | 3.11 |
| Example 2 | 188.6 | 0.53 | 1.40 | 3.04 |
| Example 3 | 194.7 | 0.49 | 1.59 | 3.28 |
| Comparative | 160.3 | 0.46 | 2.06 | 3.17 |
| Example 1 | | | | |
| Comparative | 147.2 | 1.24 | 3.28 | 5.79 |
| Example 2 | | | | |
| Comparative | 140.8 | 1.38 | 3.16 | 5.28 |
| Example 3 | | | | |
| Comparative | 100.8 | 1.99 | 5.26 | 7.81 |
| Example 4 | | | | |

It can be seen from Table 1 that an SSA of each of Comparative Examples 1 to 4 is significantly lower than an SSA of each of the examples. Because the reactor is used in Comparative Example 1 and the reaction time is short in Comparative Example 3, the mixing of raw materials is insufficient, and thus a content of zirconium in the polymer obtained after the in-situ polymerization of amino is low, such that there are few metal oxide particles after calcination, there are few vacancies in the granular structure obtained after acid-pickling of these particles, and the SSA of the material is reduced. Comparative Example 1 can show that the small-amount and multi-mixing reaction is more effective than the large-amount and long-time reaction. In Comparative Example 2, the micro-oxygen control is not conducted during the reaction, which leads to a low degree of material oxidation during the synthesis process and thus affects the pore formation. In Comparative Example 4, the anode material is prepared by direct carbonization without pore formation using the peroxide gel of the substance A, and thus has a compact structure and a small SSA.

### Test Example

Each of the anode materials prepared in Examples 1 to 3 and Comparative Example 1, acetylene black, and polyvinylidene fluoride (PVDF) were mixed in a mass ratio of 8:1:1 and dissolved in N-methylpyrrolidone (NMP), and ground to obtain a paste-like active material; then the paste-like active material was evenly coated on a Cu foil substrate, and the Cu foil substrate was dried at 85° C. for 8 h in a vacuum oven to obtain an electrode sheet; with a sodium sheet as a counter electrode and a solution of 1 mol/L lithium hexafluorophosphate (LiPF₆) in EC/DMC/DEC (a mixed solution in a mass ratio of 1:1:1) as an electrolyte, a CR2025 button battery was assembled in a glove box; and the button battery was subjected to an electrochemical performance test on an LAND battery test system at a current density of 0.1 A/g and a voltage of 0.01 V to 3 V, and test results were shown in Table 2.

TABLE 2
Electrochemical performance test data of HC anode materials

| | Initial specific | Initial coulombic | Capacity retention |
|---|---|---|---|
| | charge capacity | efficiency | after 200 |
| Sample | (mAh/g) | (ICE) (%) | cycles (%) |
| Example 1 | 327.6 | 76.7 | 83.3 |
| Example 2 | 342.1 | 77.2 | 83.8 |
| Example 3 | 346.3 | 78.3 | 85.9 |
| Comparative | 296.3 | 67.1 | 72.3 |
| Example 1 | | | |
| Comparative | 288.6 | 68.2 | 70.1 |
| Example 2 | | | |
| Comparative | 290.7 | 66.8 | 69.1 |
| Example 3 | | | |
| Comparative | 230.2 | 50.5 | 40.7 |
| Example 4 | | | |

It can be seen from Table 2 that the materials synthesized in the examples show better performance than those of the comparative examples. This is because the HC anode material prepared by the present disclosure has a large SSA, which is conducive to shortening a transmission distance of sodium ions and plays a key role in the improvement of the performance of the material.

The examples of the present disclosure are described in detail with reference to the accompanying drawings, but the present disclosure is not limited to the above examples. Within the scope of knowledge possessed by those of ordinary skill in the technical field, various changes can also be made without departing from the purpose of the present disclosure. In addition, the examples in the present disclosure and features in the examples may be combined with each other in a non-conflicting situation.

1. A preparation method of a hard carbon (HC) anode material, comprising the following steps:
S1: mixing a substance A, a first alcohol liquid, and an oxidant to obtain a peroxide gel of the substance A, and dissolving a substance B in a second alcohol liquid to obtain an amino-containing solution, wherein the substance A is at least one selected from the group consisting of a chloride and a sulfate of zirconium, germanium, and tin, and the substance B is a diamine;
S2: mixing the peroxide gel of the substance A with the amino-containing solution to allow a reaction to obtain a post-reaction slurry; and
S3: lyophilizing the post-reaction slurry to obtain a dry powder, subjecting the dry powder to calcination in a protective atmosphere to obtain a calcined material, and soaking the calcined material in an acid liquid to obtain the HC anode material.

2. The preparation method according to claim 1, wherein in S1, the first alcohol liquid and/or the second alcohol liquid are/is at least one selected from the group consisting of methanol, ethanol, 1-propanol, 2-propanol, ethylene glycol (EG), and glycerol; and a solid-to-liquid ratio of the substance A to the first alcohol liquid is (1-5):100 g/mL.

3. The preparation method according to claim 1, wherein in S1, the oxidant is 20 wt % to 45 wt % H₂O₂, and a solid-to-liquid ratio of the substance A to the oxidant is (1-10):(80-100) g/mL.

4. The preparation method according to claim 1, wherein in S1, the diamine is at least one selected from the group consisting of diaminotoluene, phenylenediamine, p-xylylenediamine, ethylenediamine (EDA), propanediamine (PDA), butanediamine (BDA), naphthylenediamine, and cyclohexanediamine; and a solid-to-liquid ratio of the substance B to the second alcohol liquid is (15-30):100 g/mL.

5. The preparation method according to claim 1, wherein in S2, a process of the mixing to allow the reaction is as follows: pumping the peroxide gel of the substance A through a first shunt pipe, pumping the amino-containing solution through a second shunt pipe, and pumping an alcohol liquid or an oxidant through an adjustment pipe, wherein the first shunt pipe, the second shunt pipe, and the adjustment pipe are joined to a confluence pipe, and a plurality of confluence pipes are joined to a main pipe; and the peroxide gel of the substance A and the amino-containing solution are mixed and react in the pipes, and finally the post-reaction slurry is obtained in the main pipe.

6. The preparation method according to claim 5, wherein in S2, the peroxide gel of the substance A is fed through the first shunt pipe at a flow rate of 0.0001 m³/min to 0.001 m³/min, and the amino-containing solution is fed through the second shunt pipe at a flow rate of 0.00015 m³/min to 0.002 m³/min.

7. The preparation method according to claim 5, wherein in S2, an oxygen content of a reaction material in the confluence pipes and the main pipe is controlled at 2,400 ppm to 8,000 ppm by controlling a pumping amount of the alcohol liquid or the oxidant.

8. The preparation method according to claim 5, wherein in S2, there are a plurality of first shunt pipes, a plurality of second shunt pipes, and a plurality of adjustment pipes; one first shunt pipe, one second shunt pipe, and one adjustment pipe are joined to one confluence pipe; and a plurality of confluence pipes are joined to one main pipe to form a tree structure.

9. The preparation method according to claim 5, wherein in S2, a reaction material in the confluence pipes and the main pipe are treated for 6 h to 18 h in total.

10. Use of the preparation method according to claim 1 in the preparation of a secondary battery anode material.

11. Use of the preparation method according to claim 2 in the preparation of a secondary battery anode material.

12. Use of the preparation method according to claim 3 in the preparation of a secondary battery anode material.

13. Use of the preparation method according to claim 4 in the preparation of a secondary battery anode material.

14. Use of the preparation method according to claim 5 in the preparation of a secondary battery anode material.

15. Use of the preparation method according to claim 6 in the preparation of a secondary battery anode material.

16. Use of the preparation method according to claim 7 in the preparation of a secondary battery anode material.

17. Use of the preparation method according to claim 8 in the preparation of a secondary battery anode material.

18. Use of the preparation method according to claim 9 in the preparation of a secondary battery anode material.
